(19) United States
(12) Patent Application Publication
(10) Pub. No.: US 2017/0286103 A1
(43) Pub. Date: Oct. 5, 2017

(54) IDENTIFYING AND CORRELATING SEMANTIC BIAS FOR CODE EVALUATION

(71) Applicant: CA, Inc., New York, NY (US)

(72) Inventor: Eladio Beguico Caritos, II, Stony Brook, NY (US)

(21) Appl. No.: 15/087,717

(22) Filed: Mar. 31, 2016

(51) Int. Cl. G06F 9/44

(52) U.S. Cl. CPC G06F 8/73

(57) ABSTRACT

System and techniques are disclosed for associating annotation semantic bias with program code. A pre-processor partitions an annotation from program statements contained within one or more source files. A lexical parser generates program statement tokens corresponding to the program statements, wherein each of the program statement tokens associates program statement text with a programming language lexeme category. The lexical parser generates one or more annotation tokens that each correspond to the annotation, wherein each of the annotation tokens associates annotation text with a natural language lexeme category. A syntactic analyzer compares the program statement tokens with the annotation tokens. A semantic analyzer determines a semantic correlation between the annotation and one or more of the program statements based, at least in part, on the results of the syntactic analyzer's comparing. A bias analyzer determines a semantic bias associated with at least one of the annotation tokens and a result processor associates at least one of the one or more program statements with the determined semantic bias based, at least in part, on the determined semantic correlation.

### BACKGROUND

The disclosure generally relates to the field of program code analysis, and more particularly to characterizing source code based on semantic bias within source code annotations.

Source code is a human-readable collection of program statements that perform specific tasks when executed by a computing device. A program statement is the smallest standalone element that expresses an action to be carried out. When compiled, a program statement may resolve to one or more machine language instructions. Source code are usually written by a computer programmer using a programming or scripting language. Programmers can add annotations such as non-executable comments to the source code to help other programmers understand the code.

### BRIEF DESCRIPTION OF THE DRAWINGS

Embodiments of the disclosure may be better understood by referencing the accompanying drawings.

FIGS. 1A and 1B depict a conceptual example of a textual code analyzer for determining code-to-annotation correlations and using the correlations to map annotation bias indicators with individual program statements.

FIG. 2 is a flow diagram depicting example operations and functions for associating annotation semantic bias with program code in accordance with some embodiments.

FIG. 3 is a flow diagram illustrating example operations and functions for determining semantic correlations within text strings contained in annotations and program statements in accordance with some embodiments.

FIG. 4 is a flow diagram depicting example operations and functions for selecting and filtering specific text strings from annotations and program statements.

FIG. 5 is a block diagram depicting an example computer system that includes a code analyzer system in accordance with some embodiments.

### OVERVIEW

Text mining is the extraction of data contained in unstructured text (i.e. natural language text). In some embodiments data is extracted and processed to derive summary data that may facilitate source code analysis. Sentiment analysis maybe utilized to mine text to identify the overall sentiment, opinions and/or evaluations expressed from unstructured text. Semantic analysis maybe utilized to understand the interpretation of a linguistic expression. Both sentiment and semantic analysis may be performed using various techniques such as natural language processing and machine learning.

A program code analysis system (“program code analyzer”) may be used to analyze the content of source files to determine the overall general state of software such as prior to a release. The program code analyzer may also be utilized to sanitize and determine the overall program correctness and performance of the program code. Performance may be determined based, in part, on error levels or other anomalous conditions. The general state of the software may be reflected by the trend in the polarity of annotation bias that may be directed or focused based on semantic correlation between the annotations (e.g. comments) and individual program statements. A high degree of semantic correlation between the annotations and the program statements may be utilized to accurately map annotation semantic bias to corresponding program statements. A low degree of semantic correlation between the annotations and the program statements may also be utilized to direct the annotation bias correlation away from non-correlated code.

Using sentiment analysis, program code comments may be identified and processed to determine the nature (e.g., subjective or objective) and polarity (i.e., positive or negative) of a programmer's or other reviewer's feedback about the function of a certain code portion such as a method or a class that could help determine how particular annotation bias indicia should be correlated to program code.

Example Illustrations

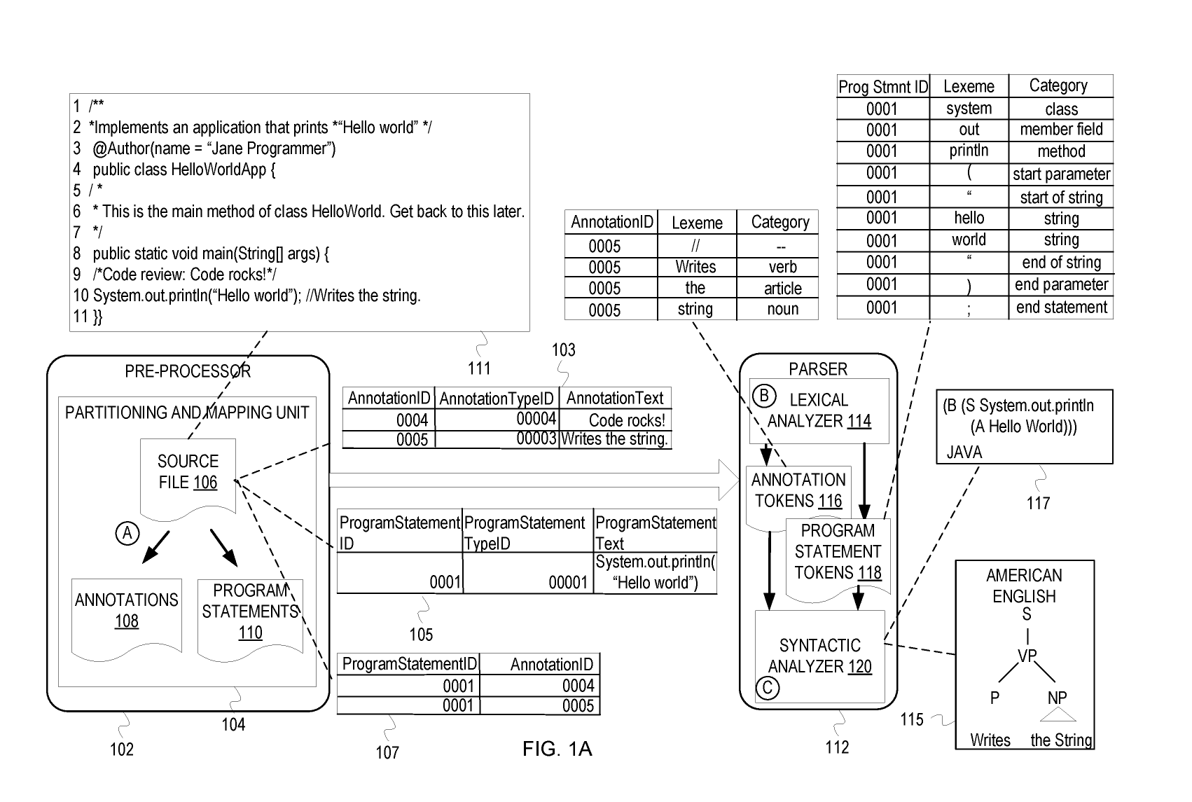

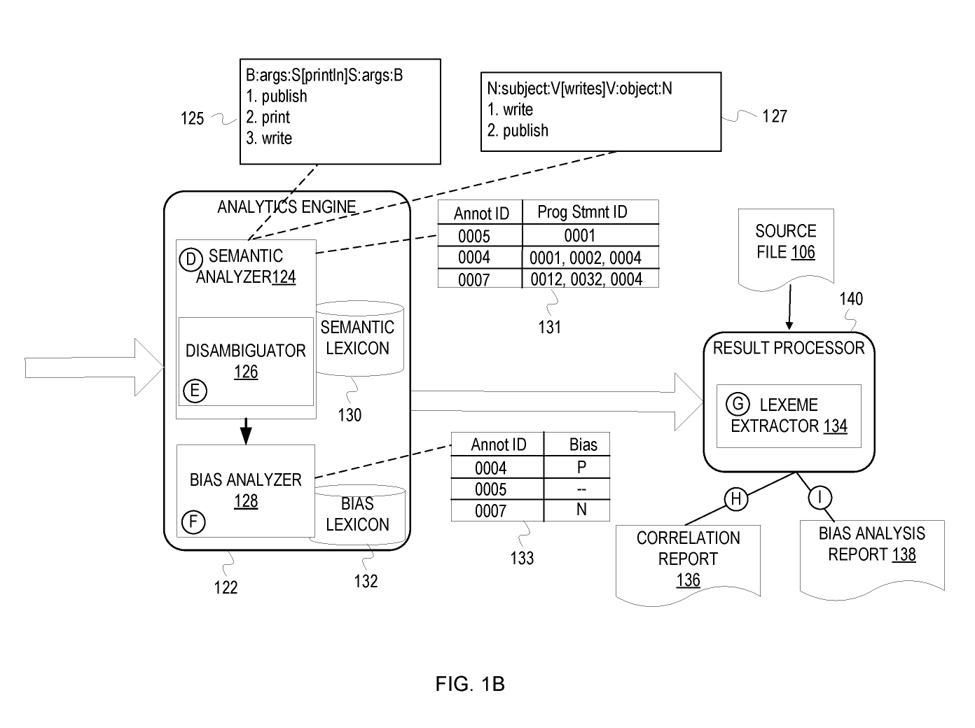

FIGS. 1A and 1B are annotated with a series of letters A-H. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

FIGS. 1A and 1B depict a conceptual example of a textual code analyzer that leverages dynamically developed lexicons for approximating correctness of code. FIG. 1A depicts code analyzer components including a source file pre-processor 102 and a parser 112. FIG. 1B depicts additional code analyzer components including an analytics engine 122 and a result processor 140. The pre-processor 102 includes a text partitioning and mapping unit 104. The parser 112 includes a lexical analyzer 114 and a syntactic analyzer 120. The analytics engine 122 includes a semantic analyzer 124, a disambiguator unit 126, and a bias analyzer 128. The result processor 140 includes a lexeme extractor 134 and generates semantic and sentiment analysis reports such as a correlation report 136 and a bias analysis report 138.

At stage A, the text partitioning and mapping unit 104 receives program statement and annotation text such as may be contained within a source file 106 that may be input to or otherwise received by unit 104. Source file 106 includes program instructions that may be compiled and executed by a processor. Source file 106 further includes non-program code artifacts such as natural language comments that are designated as non-code by a compiler-readable symbol such as a leading asterisk. While depicted as a single entity in FIG. 1A, source file 106 may comprise multiple distinct or logically associated (e.g., linked) files. Each file may include source code program statements and annotations for one or more programs such as application or system programs. Each of such program source files may include program instructions and statement that specify multiple class, methods, program statements, etc. A text content portion 111 of the total content of source file 106 is depicted as including several enumerated program lines 1-11, each containing all or portions of program statements and annotations. The depicted text content is written in Java®.

In some embodiments, unit 104 performs pre-processing functions such as filtering (sometimes referred to as “cleaning”) and otherwise structurally preparing the input for further processing by other components of the code analyzer. For example, cleaning the input may comprise removing extraneous text such as import statements. Preparing the input may include partitioning the input content of the source file 106 into annotations and program statements within an annotations file 108 and a program statements 110 file, respectively.

In some embodiments, partitioning and mapping unit 104 determines which programming or scripting language (e.g. Java, C#) that the various input components are written in. The unit 104 may determine the programming or scripting language by identifying the file name suffix of the source file 106. For example, a program code written in Java file uses “.java” as suffix. In another implementation, the unit 104 may use metadata or other techniques to determine the programming or scripting language. For instance, the unit 104 may identify syntax, coding conventions, grammar, rules, best practices and policies used by programming or scripting language (e.g. Java, Perl®, Unix® shell) for writing program statements and comments. For example, program statements have language-specific assignment, assertion, and loop conventions. Loops may be introduced by identifiers (e.g., if, while, etc.). As another example, program statements may also have language-specific reserved keywords (e.g. abstract, assert, etc.) which cannot be used as names of variables, methods, functions, classes or as any other identifier.

The annotations within source file 106 may be embodied as metadata, programmer comments, and other information that is not compiled or executed. An annotation, such a comment, typically includes a language-specific delimiter that the compiler interprets to pass over and not attempt to compile the annotation. Each programming or scripting language also has its own annotation convention. For example, Java supports two kinds of comments: implementation and documentation comments. Implementation comments may comprise multiple lines (multiple line style) that begin/open with /* and end/close with */ (“/* . . . */”), or may be single lines (single line style) marked at beginning with two slashes (“//”). Documentation comments maybe delimited by /** . . . */.

For example, within text content 111 program lines 1 and 2 constitute documentation lines with line 1 specifying the beginning of a documentation comment, and “Implements an application that prints ‘Hello world’” contained in line 2. The text in line 2 inside the documentation delimiters (/** . . . /*) is an example of a documentation comment. The text in program line 3 is an example of a predefined Java annotation. Java annotations allows programmers to add metadata information to the source code. In the example, the programmer's name, “Jane Programmer,” was added. The text in program line 6 is an example of a comment inside the multiple line style delimiters. The text in line 9 is an example of a code review annotation inside a multiple line style delimiters. The code review annotation may be entered by another programmer or generated by automated code review applications. The code review may not be delimited by the comment delimiters. Other delimiters or identifiers may be used to signal that the text is a code review annotation. Line 10 is an example of a program statement with an inline comment. The program statement ends with a semicolon. The inline comment starts after the single line style delimiter. Other types of annotations may provide instructions to the compiler. For example, @SuppressWarnings instructs the Java compiler to suppress specific warnings that may otherwise be generated in response to certain conditions. Therefore, while some types of annotation may affect the operation/output of a compiler, annotations do not affect the execution or correctness of compiled program code.

Implementation comments may contain information about a particular application implementation. An implementation comment either immediately precedes or is located in the same line as the program instruction implementation it is describing. Multiple line style comments usually precede the code it describes while single style comments (“inline comments”) can start before or at the end of the line of code.

The partitioning and mapping unit 104 may also determine the natural language (e.g. American English, German) used in the annotations (e.g. code annotations, code review, comments, etc.). In an embodiment, the natural language identification of an annotation may be utilized to determine whether to translate the annotation or other annotations to another language. For instance, unit 104 may identify or otherwise determine that the text within annotation lines 2 and 6 of text content 111 is American English text and, being processed in association with other American English text annotations, requires no translation. If, however, one or more annotations within a given source file are determined to be written in a different language than other annotations, the unit 104 may call a translation function to translate the differing text languages to a common natural language.

The program statements comprise text words and symbols having syntactic and semantic structures determined by the programming or scripting language. For instance, the text in line 4 of content text 111 is an example of a class definition. The class definition starts with the access modifier (e.g. public, protected, private). The class definition uses the keyword “class” to declare the class followed by the name of the class. In this example, the name of the class is HelloWorld, and the constituent program statements of the class are incorporated with a pair of braces. Methods, constructors, program statements, etc. that are inside the class braces are part of the class. The text in line 8 is an example of a method that starts with an access modifier (i.e., public). The words static and void are reserved keywords in Java. The main method has a pair of parenthesis that include the parameters passed to the method for processing. In this example, the parameter is an array of string called “args” which is a standard convention for a main method in Java.

Lines of code, or code lines, can be physical or logical. Physical code lines, such as the code lines enumerated in text content 111, comprise strings of characters, symbols, words, etc. within a single physically enumerated line excluding any annotation text. The line numbers 1-11 enumerated in text content 111 are not part of the program code. A logical code line encompasses an executable statement and therefore may occupy one or more physical code lines. As utilized herein, a line of code, or code line, refers to a logical code line. Documentation annotations/comments, which generally precede one or more code lines that are being documented/described, provide information regarding Java classes, interfaces, constructors, methods and fields. For example, a documentation comment occupying one or more lines prior to one or more method code lines may specify the method's function and purpose, as well as assumptions and limitations associated with the method.

In the depicted embodiment, unit 104 generates an annotation table 103 containing records for the example annotations in text content 111. Each record within the annotation table 103 includes an annotation identifier field, AnnotationID, an annotation type identifier field, AnnotationTypeID, and an annotation text field, AnnotationText. The AnnotationID field for each row-wise record specifies an identifier for an individual annotation. For instance, the AnnotationID field entry for the first record within the annotation table 103 specifies a numeric code 0004 that is used by the components within the code analyzer to individually represent the annotation at enumerated line 9 of text content 111. The AnnotationTypeID field for each record specifies an identifier for an annotation type/category. For instance, the AnnotationTypeID field entry for the first record within annotation table 103 specifies a numeric code 00004 that may represent a documentation type comment. The AnnotationText field for each record specifies the text content of the annotation. For example, the AnnotationText field entry for the second record within annotation table 103 contains the annotation text “Writes the string” that was read from program line 10.

Partitioning and mapping unit 104 also generates a program statement table 105 containing records for the example program statements in text content 111. Each record within program statement table 105 includes a program statement identifier field, ProgramStatementID, a program statement type identifier field, ProgramStatementTypeID, and a program statement text field, ProgramStatementText. The ProgramStatementID field for each row-wise record specifies an identifier for an individual instance of a program statement. For instance, the ProgramStatementID field entry for the first record within the table 105 contains a numeric code 0001 that is used by the components within the code analyzer to represent the individual instance of the program statement at enumerated line 10 of text content 111. The ProgramStatementTypeID field for each record specifies an identifier for a type/category of the program statement. For example, the ProgramStatementTypeID field entry for the first record within table 105 specifies a numeric code 00001 that may represent a print output type of program statement. The ProgramStatementText field for each record specifies the text content of the program statement. For example, the ProgramStatementText field entry for the first record within table 105 contains the Java program code text that was read from program line 10 of text content 111.

After or as part of partitioning the text content of the source file 106, the unit 104 logically associates one or more of the annotations within annotation file 108 to one or more of the program statements within program statement file 110. For example, each annotation in annotations file 108 can be mapped to the one or more program statements in program statements file 110 that it describes. Therefore, the mappings may be one-to-one, or one-to-multiple. For example, an inline comment may typically map to a single code line while a documentation comment may be mapped to multiple code lines that comprise a method or class. In some embodiments, partitioning and mapping unit 104 may utilize data structures such as tabular records or an associative array such as may be implemented by a hash table to associate annotations with program statements.

In some embodiments, unit 104 generates an associative data structure such as a linking table 107 to map the annotations with the program statements. Unit 104 generates the mappings by comparing and associating the program statement identifiers with respective annotation identifiers. In the depicted example, the program statement identifier 0001 is associatively mapped to annotation identifiers 0004 and 0005. Embodiments described herein map annotations to corresponding program statements and further process annotation text to determine a characterization of the corresponding (i.e., mapped) program statements. Comments and/or code reviews may be processed and/or analyzed separately or in combination with the program statements referenced by the annotation.

At stage B, the lexical analyzer 114 resolves annotation text within the annotations file 108 and program statement text within program statement file 110 into annotation tokens 116 and program statement tokens 118 in a tokenization process. In an embodiment, lexical analyzer 114 reads the annotation and program statement text from the records within annotations table 103, program statements table 105, and linking table 107. The generated annotation tokens 116 and program statement tokens 118 may include information utilized by the code analyzer to identify and categorize text items (e.g., words, phrases, idioms, fragments) within the source file 106. A token is a data structure representing a lexeme in a manner that expressly assigns and associates a lexeme category with the lexeme. A lexeme is generally a string of characters that form a defined syntactic unit such as a word, idiom, phrase, etc. Lexical analyzer 114 may configure the tokens to categorize the lexemes as constants, operators, punctuations and reserved words, for example. Lexical analyzer 114 may perform additional tokenizing procedures such as cleaning (e.g. removal of the delimiters), negation handling, removal of stop words (e.g. to, of), and stemming (reducing words to common base form).

In some implementations, the lexical analyzer 114 may identify features comprising words, idioms, phrases, and other character strings in the annotation text that indicate a positive or negative bias. The lexical analyzer 114 may apply a pattern matching algorithm such as a nearest neighbor or k-nearest neighbor (k-NN) method to classify the features based on a library. For example, lexical analyzer 114 may access categorized sets of classifier patterns to identify a set with which to perform pattern matching. Lexical analyzer 114 compares the annotation character strings with each of the selected classifier patterns using the pattern matching algorithm to determine matches or closest matches that comprise the identified features. Feature identification makes training and applying a downstream classifier more efficient by decreasing the size of the lexicon utilized by other code analyzer components to determine a semantic bias. In some embodiments, weighting values may be associated with each of the identified features such as may be based on the frequency with which the feature occurs in the annotation text.

In some embodiments, annotations may be written in a natural language having characters and/or multi-character constructs (e.g., words) that differ from the characters and words used to construct the program statements. If the annotation natural language is determined to be semantically/linguistically inconsistent with the characters and multi-character constructs used in the program statements, lexical analyzer 114 may translate or otherwise convert the lexeme entry text for each annotation token to a consistent language. The lexical analyzer 114 may perform a linguistic matching algorithm to determine the language in which the annotations are written. The annotations language determination and comparison with program statement text linguistics may be performed either before or after tokenization. In response to determining that annotations are written in a language (e.g. Hindi, Chinese) having differing linguistics than those used in the program statements, a translator module (not depicted) in lexical analyzer 114 may translate the lexeme text in the annotation tokens accordingly. Dictionary based or rule-based algorithms may be utilized to perform the translation.

Annotation tokens 116 include example tokens generated from an inline comment, “Writes the string.” As shown, four tokens are generated corresponding to the lexemes: //, Writes, the, and string. In an alternate embodiment, the article “the” may be specified in a word or string exclude list and would not be included in the generated tokens. The category entries in each of annotation tokens 116 (e.g., verb) are based on American English grammar rules. Each of the annotation tokens 116 further includes an annotation ID entry that specifies the identifier of the annotation from which the corresponding token lexeme was read. For example, the four depicted tokens among annotation tokens 116 each include an annotation ID “0005.”

The tokenizing method performed by lexical analyzer 114 to tokenize program statements may differ from the method used to tokenize annotations. This may be due to unique characteristics of program statements. Naming conventions used for naming methods, classes or variables may adhere to comparative performance results which may differ from one programming language to another. For example, a method or class name indicates a function category for the overall method or class that comprises multiple program statements each having respective function categorizations. The naming convention may use a verb-noun method such as CalculateInvoiceTotal( ). The first letter of each word lexeme is usually capitalized in method or routine names. Camel casing in which the first letter of each word except the first is capitalized (e.g. invoiceTotal) is generally used for variables and method parameters. Another naming convention variation may be the use of underscores to concatenate multiple words. The lexical analyzer 114 may partition the concatenated words and generate a token for each. For example CalculateInvoiceTotal( ) may be partitioned and processed to generate three lexemes: calculate, invoice and total. Because these best practice based conventions may not always be followed, the lexical analyzer rules may be updated to account for non-conventional practice used in the program code being analyzed.

Program statement tokens 118 include example tokens generated for a program statement, “System.out.println(“Hello world”).” As shown, ten tokens are generated corresponding to: system, out, println, (, “, hello, world, ”,), and ;. In an alternate embodiment, the lexical analyzer 114 may stem the program statement text string “println” into a text lexeme entry “print” within program statement tokens 118. The category field entries in each of program statement tokens 118 are based on Java programming syntax rules (e.g., String, class). Similar to the annotation tokens 116, each of program statement tokens 118 includes a lexeme entry that is associated with a lexeme category and a program statement ID.

At stage C, the syntactic analyzer 120 receives and processes the annotation and program statement tokens to generate corresponding syntax trees. As utilized herein a syntax tree (sometimes referred to as a parse tree) is an associative data structure that defines the syntactic structure of a multi-lexeme construct, such as a sentence, in context-free grammar. In the depicted embodiment, syntactic analyzer 120 processes program statement tokens 118 with respect to determined programming language syntax, rules, and policies to generate a syntax tree 117. In the syntax tree 117 (textually represented as B (B (S System.out.println (A Hello World))), B refers to Body, S refers to Statement, A refers to arguments.

Syntax tree 115 is an example syntax tree generated from the annotation tokens 116. In the syntax tree 115 (textually represented as S (VP Writes (NP the string))), S represents sentence, VP represents verb phrase, and NP represents noun phrase. The syntactic analyzer 120 generates the syntax tree 115 by processing the annotation tokens 116 with respect to a natural language syntax that is associated with the natural language for the annotation text. The rule set applied by the syntactic analyzer 120 for generating the syntax tree 115 may differ from the rule set utilized to generate the syntax tree 117 from the program statement tokens 118. For example, syntactic analyzer 120 may apply natural language grammar rules to the annotation tokens 116 in contrast to the programming language syntax rules applied to generate syntax tree 117. In addition to applying different syntax tree rule sets, syntactic analyzer 120 may apply different formats and/or symbols to represent the constituent components of the respective syntax trees 115 and 117. As further depicted in FIG. 1A, the syntax tree 115 may be entered into a file or other data structure in association with a natural language identifier specifying American English, for example. Similarly, the syntax tree 117 may be entered into a file or other data structure in association with a programming language identifier specifying Java, for example.

At stage D (FIG. 1B), the semantic analyzer 124 uses the semantic lexicon 130 to interpret the generated syntax trees 115 and 117. The semantic lexicon 130 may comprise one or more wordlists configured as dictionaries, semantic networks, etc. In an embodiment, semantic analyzer 124 selects lexical components of lexicon 130 from a set of multiple lexicons based on either or both the annotation language (e.g., English, French) and the linguistics of the programming language (e.g., American English Java). The programming language(s) linguistics and the annotation text language may be specified, such as within a file, in association with the respective syntax trees. For example, in response to determining from a file associating syntax tree 115 with American English, the semantic analyzer 124 selects an American English wordlists configured as dictionaries, semantic networks, etc. to include within the lexicon 130. Similarly, in response to determining from a file associating syntax tree 117 with Java, the semantic analyzer 124 selects Java lexeme lists configured as dictionaries, semantic networks, etc. to include within the lexicon 130. In such an embodiment, the semantic analyzer 124 may utilize the American English wordlists to process annotation text within the syntax tree 115. The semantic analyzer 124 may utilize the American English wordlists in combination with the Java lexeme lists to process the program statement text within syntax tree 117.

Semantic analyzer 124 receives input from parser 112 and/or source file pre-processor 102 including annotation tokens 116, program statement tokens 118, syntax trees 115 and 117, and additional tree-related data such as natural language and programming language identifiers associated with each of the trees. In addition, semantic analyzer 124 receives the program statement-to-annotation mapping information contained in linking table 107. Semantic analyzer 124 interprets the syntax trees 115 and 117 to identify multi-lexeme constructs, such as sentences, based on the syntactic structure of the context-free grammar used to generate the syntax trees. The semantic analyzer 124 uses the multi-lexeme construct identifications in combination with the token encoded lexeme categorizations to determine semantic correlations between annotations and program code. For example, the semantic analyzer 124 may determine to compare one or more program statements with an annotation such as a documentation comment based on associations specified by the linking table 107.

In one aspect, the comparisons determine whether and which portions of the program text are correlated with the associated annotation. In another aspect, the comparisons and resultant correlations or non-correlations may reveal inconsistencies or anomalies that may arise, for example, due to incorrect positioning of the annotations within a source file. For example, semantic analyzer 124 may determine a semantic correlation between the program text contained in program line 10 of text content 111 and the annotation text constituting the inline comment in the same line. The semantic analyzer 124 may execute operations based on semantic structure rules to determine whether or not a correlation exists. For instance, semantic analyzer 124 may be configured to identify or otherwise determine that the program text constitutes a method and, in response thereto, identify and use annotation lexemes categorized within the tokens as verbs for comparison. The semantic analyzer 124 may be configured to implement a variety of code-to-annotation comparison rules. For example, the semantic analyzer 124 may be configured to identify and select a subject noun in an annotation (as identified in an annotation token) in response to identifying an associated program statement as comprising program statement variables.

In the depicted embodiment, the semantic analyzer 124 identifies the program text in program line 10 as a method based on the interpretation of syntax tree 117. More specifically, the multi-lexeme statement System.out.println represented in syntax tree 117 is interpreted to identify a method that is textually characterized as “println.” Based on a selected compare rule, the semantic analyzer 124 responds by searching for a verb in the associated annotation text. In the depicted example, the semantic analyzer 124 identifies and selects the inline comment verb “write” for comparison from among the annotation tokens that are included in the same syntax tree 115.

The semantic analyzer 124 identifies and processes sets of synonyms for the program statement lexeme “println” and the annotation lexeme “writes” that were selected based on applying the compare rule to the syntax tree interpretations. In the depicted embodiment, the semantic analyzer 124 uses “println” as a search key to search for synonymous terms within lexicon 130. Based on the search, the semantic analyzer 124 retrieve a synonym set 125 that specifies three enumerated synonyms, publish, print, and write. Prior to searching the lexicon 130, the semantic analyzer 124 may stem “println” to “print” in order to provide a more reliable synonym search result from an American English lexical component within the lexicon 130.

The code-to-annotation compare process continues with semantic analyzer 124 accessing lexicon 130 to retrieve synonyms for the selected inline comment verb “writes.” The semantic analyzer 124 uses “writes” as a search key to search for synonymous terms within lexicon 130. Based on the search, the semantic analyzer 124 retrieve a synonym set 127 that specifies two enumerated synonyms, write and publish.

The semantic analyzer 124 compares, such as by pattern matching, the method subject term “println” and the three identified synonyms with the annotation verb “writes” and the two identified synonyms. In the depicted example, the semantic analyzer 124 determines “write” and “publish” as exact matches between the synonym sets for “println” and “writes.” The number of exact matches to establish a correlation may vary depending on implementation. In the depicted example, the semantic analyzer 124 may determine a correlation based on one, two, or more exact matches between the code and annotation synonyms sets. In addition, or alternatively, the semantic analyzer 124 may identify a single correlation synonym from among multiple matching synonyms based on pattern matching the matching each member of each matching pair with its respective principle lexeme. For instance, the semantic analyzer 124, having determined the matching synonym pairs write and publish may then pattern match the annotation write lexeme with the principle lexeme “writes” and determine a closer match than the annotation publish and also a closer match than the matches between either of the program statement lexemes “publish” and “write” and the lexeme principle “println.” As depicted, the semantic analyzer 124 generates a correlation report 131 comprising three entries corresponding to each of annotation IDs 0005, 0004, and 0007. Each of the correlation report entries includes a program statement ID field in which the semantic analyzer 124 specifies the one or more program statement IDs of program statements that are determined to be correlated with the annotation.

The code analyzer components depicted in FIGS. 1A and 1B may utilize the determined correlation(s) in several ways. The semantic analyzer 124 may utilize the determined correlation as an indicator that the correlated program statements are consistent with a programmer's intent. A determined non-correlation may be interpreted as an anomaly in response to which the semantic analyzer 124 may assert a flag associated with the program statement(s) and/or annotation(s). In addition, or alternatively, a determined non-correlation may indicate incorrect positioning of an annotation among the program statements within a source file.

At stage E, the disambiguator 126 searches for and identifies program statements and/or annotations that are flagged by the semantic analyzer 124. The disambiguator 126 analyzes the syntax trees containing the flagged program statements and annotations to identify or otherwise determine a secondary interpretation. To determine possible secondary interpretations, the disambiguator 126 may utilize one or more supplemental synonym sets. Semantic analyzer 124 processes the derived secondary interpretations to determine whether a sufficient similarity exists. In some embodiments, disambiguator 126 identifies associations to further classify the interpretation of some phrases. In response to determining a similarity between the flagged annotation and program statement based on the secondary interpretations, the disambiguator 126 may remove the flag. A separate list is maintained for flagged annotations and program statements. In other implementation, only one list is maintained and the separation is solely logical.

In some embodiments, the semantic analyzer 124 may utilize the correlation information to identify program statements that are most closely associated with an annotation and/or with sub-component lexemes of an annotation. This mapping of greater or lesser correlations between individual program statements and an annotation or sub-components of the annotation enables the code analyzer components to more efficiently apply semantic bias in a targeted manner within a multiple program statement code construct such as a multiple code line routine.

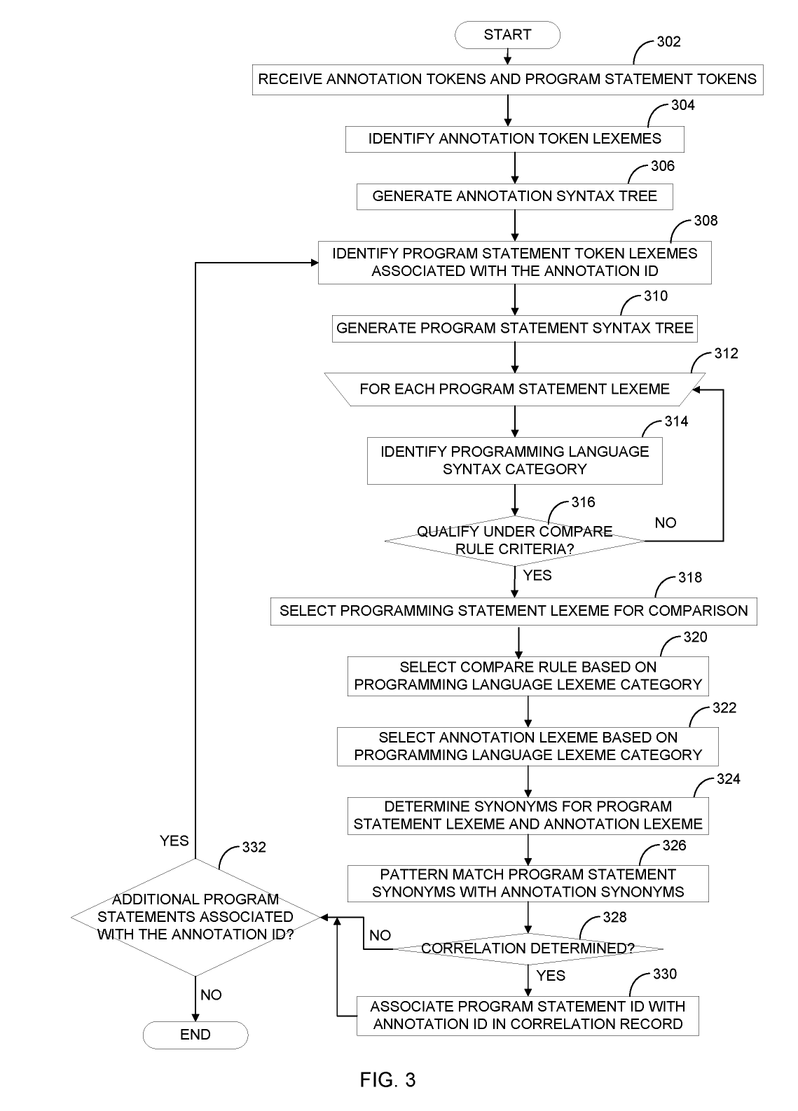

At stage F, the bias analyzer 128 receives the syntax tree 115 and the annotation tokens 116 to determine, based on information from the bias lexicon 132, a bias value, if any, associated with one or more portions of an annotation. Each of annotation tokens 116 may be analyzed by itself or in combination with other tokens specifying words, symbols, phrases, fragments and/or sentences associated with the same annotation ID. The bias analyzer 128 first determines whether the annotation token lexemes collectively indicate a semantic bias and, if so, determines based on bias classifications within the lexicon 132 whether the bias has a positive or negative polarity. In some embodiments, the bias analyzer 128 may perform sentiment analysis to determine a bias (i.e., subjective expression or connotation) and/or to determine the polarity of the bias. Additional details regarding how the bias analyzer 128 may determine semantic bias and bias polarity are depicted and described with reference to FIG. 3.

In addition to sentiment analysis, the bias analyzer 128 may utilize a pattern matching algorithm to match annotation character strings with one or more lists of character strings (e.g., words, phrases) contained within the bias lexicon 132. For example, the bias analyzer may determine whether a given annotation character string conveys a bias based on whether or not the character string matches one or more of character strings listed within the bias lexicon 132. Each of the character string entries within the bias lexicon 132 may be associated with specified polarity (positive or negative) and a bias weight value. The weight values may be added to determine a cumulative bias of a given annotation or a sub-part of the annotation (e.g., one or more lexemes within the annotation). The bias lexicon 132 may be generated and/or updated, at least in part, from previous source code bias analyses or as a result of machine learning.

The bias analyzer 128 may utilize several factors to determine whether to assign a bias value or indicator to a given annotation. For example, in response to identifying negations, diminishers, and/or intensifiers in the annotation the bias analyzer 128 may adjust the bias value accordingly. Other words such as modals (e.g., should, could), connotative qualifiers (e.g., but, furthermore) may also be assessed to determine the bias value. In response to determining and assigning a negative bias value to an annotation or annotation lexeme, the bias analyzer 128 may flag the corresponding program/annotation lines within the source file 106. In addition, or alternatively, the bias analyzer 128 may access syntax tree 115 to identify and flag phrases and/or sentences corresponding to the negative bias determination.

The bias analyzer 128 generates an annotations bias report 133 that includes an entry for each of three annotations having annotation IDs 0004, 0005, and 0007. In addition to the annotation ID field each of the report entries includes a bias indicator field that specifies P for a determined positive bias and N for a determined negative bias. As shown, the annotation ID 0004 is associated with a positive bias, the annotation ID 0005 is associated with null indicating no bias determined, and annotation ID 0007 is associated with a negative bias.

The correlation report 131 and the annotation bias report 133 are received as input by the result processor 140. At stage G, the lexeme extractor 134 detects one or more triggering criteria based, at least in part on the data received in the annotation bias report 133. To detect a triggering criterion, the lexeme extractor 134 reads the annotation bias report 133 to identify annotation IDs that are associated with a negative bias value or indicator. The lexeme extractor 134 compares the annotation lexemes associated with the identified annotation IDs with pre-specified text patterns or character strings to determine whether a triggering condition exists. In another implementation, the lexeme extractor 134 may utilize rule-based analysis to determine a triggering condition, such as detection of objectionable language. The lexeme extractor 134 may perform different actions depending on the criteria triggered. For example, the lexeme extractor 134 may access source file 106 and delete the objectionable terms and phrases found in the corresponding annotations.

At stage H, result processor 140 generates correlation report 136 from the results of the analysis by semantic analyzer 124. Semantic correlation report 136 contains all the annotations and program statements flagged by the semantic analyzer 124 and not actioned by the lexeme extractor 134. Result processor 140 also generates a bias analysis report 138 based on data received from the bias analyzer 128. Bias analysis report 138 contains all the annotations flagged by the bias analyzer 128 and not deleted or marked by lexeme extractor 134. The correlation report 136 may show semantic correlation per line of code, method, group of methods, class, group of classes or the entire application. These semantic correlation results may be aggregated. For example, semantic correlation for each line of code in a method may be aggregated to determine the semantic correlation for the method. The bias analysis report 138 may show sentiment confidence per line of code, method, group of methods, class, group of classes or the entire application. These sentiment confidence results may be aggregated. For example, semantic correlation for each line of code in a method may be aggregated to determine the semantic correlation for the method. The reports may be printed out or be shown in a computer dashboard.

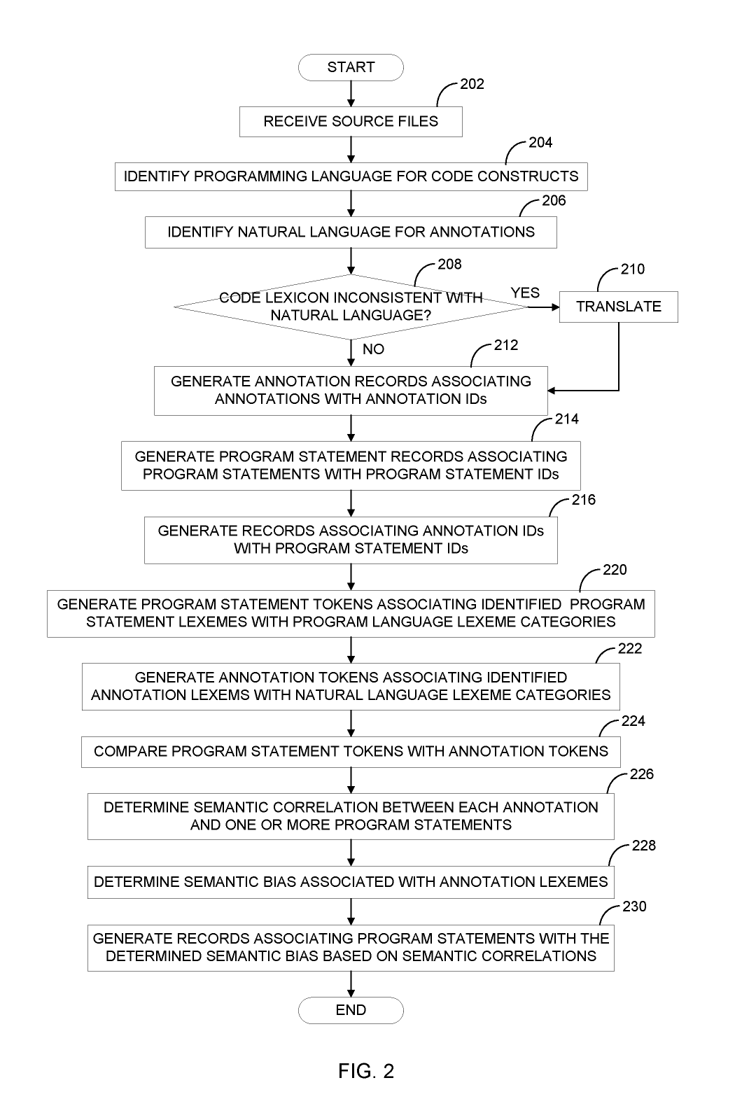

FIG. 2 is a flow diagram depicting example operations and functions for associating annotation semantic bias with program code in accordance with some embodiments. The operations and functions depicted in FIG. 2 may be implemented by components within a code analyzer such as that shown and explained with reference to FIGS. 1A and 1B. The process begins as shown at block 202 with a source file pre-processor receiving one or more source files that contain program statements that may be compiled by a compiler to form an executable program. The program statements are expressed in one or more source code programming languages such as Java or C++®. The received source file(s) further include annotations, such as programmer comments, that include inline annotation designators such as asterisks that identify each line of an annotation.

The pre-preprocessor may include a mapping and partitioning unit that processes the source file content to identify the particular programming language in which the program statements are expressed (block 204). For instance, the mapping and partitioning unit may read the source file name, metadata associated with the source file, and/or text associated with code constructs within the file to determine the programming language. The mapping and partitioning unit may further identify or otherwise determine the natural language in which one or more of the annotations are expressed (block 206). For instance, the mapping and partitioning unit may read file metadata and/or apply a text categorization or other language recognition algorithm to identified annotations to determine the natural language in which each annotation is expressed.

Next, as shown at block 208, the mapping and partitioning unit may determine whether the code linguistics utilized by the programming language are inconsistent with the natural language lexicon. In response to determining the programming language to be inconsistent with natural language of one or more annotations, the unit translates the inconsistent annotations to conform (block 210). If the annotations are lexically consistent with the programming language, or following translation, control passes to block 212 with the beginning of a partitioning phase in which one or more identified annotations are partitioned from the program statements in data structures external to the received source files. As shown at block 212, the mapping and partitioning unit generates annotation records that each associate annotation text with an annotation ID. The unit further generates program statement records that each associate program statement text with a program statement ID (block 214). The mapping and partitioning unit may also generate records that each associate an annotation ID with a program statement ID (block 216). For example, the unit may apply conventions, policies, and rules associated with the identified programming language to identify associations between an annotation and one or more individual program statements. The unit may then enter the associations in a code-to-annotation linking table.

The process continues with the program statement records, the annotation records, and the linking table being received as input by parser unit that includes a lexical analyzer and a syntactic analyzer. As shown at block 220, the lexical analyzer processes the program statement records to generate program statement tokens. More specifically, the lexical analyzer may identify one or more lexemes within each of the text content fields of a given program statement record. The lexical analyzer generates a token data structure for each identified lexeme that includes the lexeme itself as an entity field that is associated with a lexeme category. As explained with reference to FIG. 1A, the lexeme category may be determined based on the identified programming language.

At block 222, the lexical analyzer processes the annotation records to generate annotation tokens. More specifically, the lexical analyzer may identify one or more lexemes within each of the text content fields of a given annotation record. The lexical analyzer generates a token data structure for each identified lexeme that includes the lexeme itself as an entity field that is associated with a lexeme category. As explained with reference to FIG. 1A, the lexeme category may be determined based on the identified natural language in which the respective annotation is expressed.

The generated program statement tokens and annotation tokens are passed to or otherwise received as input by the syntactic analyzer and an analytics engine. As shown at block 224, the analytics engine and the syntactic analyzer perform operations and functions for directly or indirectly comparing the program statement tokens with the annotation tokens. The analytics engine further determines a correlation of one or more of the program statements with each of the annotations based on the token-based comparisons (block 226). In some embodiments, the analytics engine generates correlation records that each associate an annotation ID of an annotation with one or more program statement IDs of the program statements that were determined to semantically correlate with the annotation. The compare and correlate functions depicted at blocks 224 and 226 are depicted and described in further detail with reference to FIG. 3.

The process continues at block 228 with the analytics engine determining a semantic bias associated with one or more of the constituent lexemes of each annotation. In response to identifying or otherwise determining the semantic bias, a bias analyzer may generate annotation bias records that each associate an annotation ID with a bias indicator that may express a bias polarity. The annotation bias records and the correlation records are received as input by a result processor. The process concludes as shown at block 230 with the result processor generating records that each associate one or more program statements with the determined semantic bias. For example, the result processor may determine from an annotation bias record that annotation ID 0007 is associated with a negative bias indicator. In response, the result processor may identify, from the correlation records, which program statement(s) are semantically correlated with annotation ID 0007. The result processor may then generate a code report record in which the identities of the program statements are associated with the bias indicator.

FIG. 3 is a flow diagram illustrating example operations and functions for determining semantic correlations within text strings contained in annotations and program statements in accordance with some embodiments. The depicted operations and functions may be performed by various code analyzer components such the syntactic analyzer and semantic analyzer shown in FIGS. 1A and 1B. The process begins as shown at block 302 with the syntactic analyzer receiving annotation tokens and program statement tokens that were generated by a lexical analyzer. At block 304, The syntactic analyzer identifies tokens as annotation tokens having a common annotation ID, and in response, generates an annotation syntax tree having nodes that may label one or more annotation lexemes (block 306). The syntactic analyzer identifies program statement tokens and determines associations between the program statement tokens and one or more of the annotation tokens having the same annotation ID based on a linking table generated by a source file pre-processor (block 308).

At block 310, the syntactic analyzer generates a program statement tree for the program statement tokens identified as associated with the annotation ID. The annotation syntax tree, the program statement syntax tree, and the corresponding tokens are received as input by the semantic analyzer. As shown at block 312, the semantic analyzer processes each program statement lexeme in the program statement syntax tree beginning with identifying the programming language syntax category specified by the corresponding node in the program statement syntax tree (block 314). At block 316, the semantic analyzer determines, based on the identified syntax category, whether the lexeme qualifies to trigger selection of a compare rule. If not, control passes back to block 312 for processing of a next lexeme in the program statement syntax tree. In response to determining that the lexeme qualifies to trigger selection of a compare rule, the semantic analyzer selects the lexeme to be compared with an annotation lexeme (block 318).

At block 320, the semantic analyzer selects a compare rule among a set of compare rules based on a program statement lexeme category that is specified by the program statement token. For instance, the semantic analyzer may select a rule that specifies that the program statement lexeme will be compared with a annotation lexeme categorized as verbs in response to determining that the token containing the program statement lexeme specified the lexeme category “method.” The process continues at block 322 with the semantic analyzer selecting an annotation lexeme based on the rule (i.e., based on the programming language lexeme category of the program statement lexeme). The semantic analyzer then accesses natural language and/or programming language lexicons to determine sets of synonyms for each of the program statement lexeme and the annotation lexeme (block 324). Next at block 326, the semantic analyzer applies a pattern matching algorithm, such as a character string matching algorithm, to identify matches between the sets of synonyms. The matches between the synonym sets are utilized by the semantic analyzer to determine a semantic correlation or semantic non-correlation between the program statement lexeme and the annotation lexeme. In response to determining a semantic correlation at block 328, the semantic analyzer generates or updates a correlation record to associate the program statement ID with the annotation ID (block 330). Following generation or update of the correlation record for each of the program statement lexemes in the syntax tree, control passes to block 332 with a determination of whether other program statement tokens that are also associated with the annotation ID remain unprocessed. If so, control returns to block 308 and the processing of each program statement syntax tree continues until all program statement tokens that are associated with the annotation ID have been processed and the process ends.

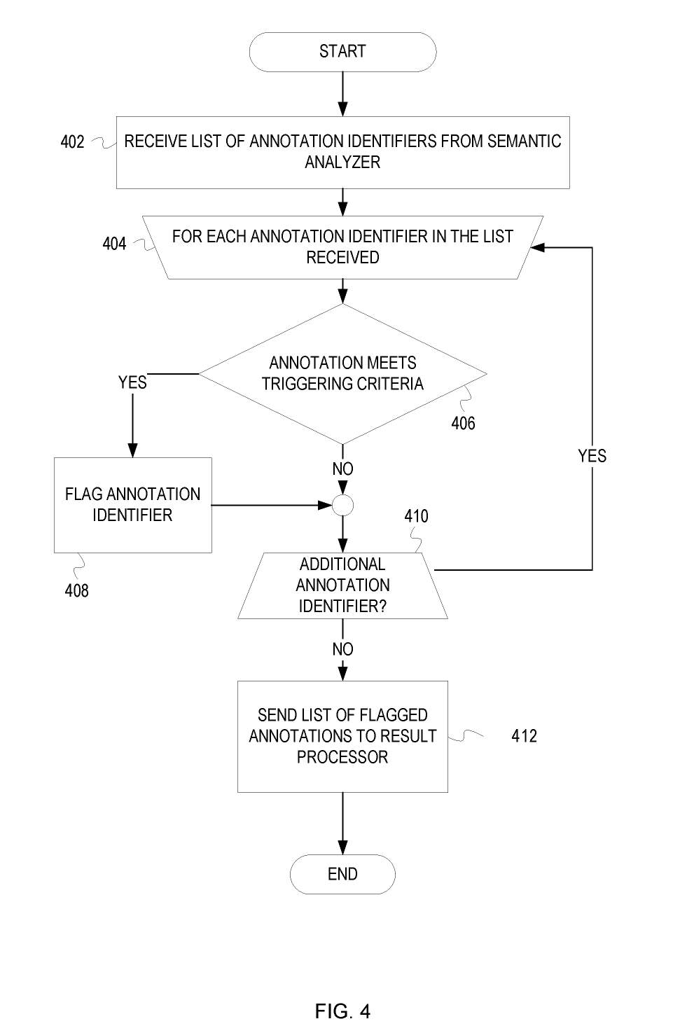

FIG. 4 is a flow diagram depicting example operations and functions for filtering and selecting specific text strings from annotations and program statements. FIG. 4 refers to a bias analyzer performing the operations for naming consistency with FIGS. 1A and 1B even though identification of program code can vary by developer, language, platform, etc.

A bias analyzer receives data from the semantic analyzer (block 402). The data may be an enumerated list or table of all the annotation identifiers. The annotations corresponding to the annotation IDs include programmer comments and/or code review comments that include inline annotation designators such as asterisks that identify each line of an annotation. The annotations may include information such as annotation text, and an index that maps the annotation to a specific file, class, method and/or line of code. The data may also include the synonym sets determined by a semantic analyzer.

The bias analyzer begins to traverse each annotation identifier (block 404). If the data is in a list format, the bias analyzer may begin from the beginning of the list of annotations but it is not necessary.

For each annotation in the list, the bias analyzer determines if the annotation meets a triggering criteria (block 406). The bias analyzer can use different mechanisms to make this determination. The bias analyzer can use pattern matching techniques to determine if the annotation matches a word or phrase. The bias analyzer may also use the synonym set to determine if the annotation is similar to a word or phrase that needs to be filtered. The triggering criteria may be updated. For instance, an administrator may change or add words and/or phrases that needs to be filtered. The administrator may also remove a word or phrase from the triggering criteria. The triggering criteria may also be updated by the analytics engine or result processor.

If the annotation matches the triggering criteria, then the annotation is flagged (block 408). For example, a bit may be updated. Other techniques may be used to flag the annotation. The annotation may not be an exact match of the criteria and/or criterion. A rule may be set that a criterion is triggered even with a partial match. The analytics engine or an administrator may update rule and/or criterion. The criterion may be a name, number, word, phrase, idiom, sentence etc. that needs to be removed or masked from the source code for example. In another implementation, the triggering criterion may be the annotation meeting a certain polarity classification or polarity score threshold. In yet another implementation, the bias analyzer will incorporate the syntactic structure of the annotation. The bias analyzer may also incorporate analysis of the domain in identifying the nature and/or the polarity of a text. For example, words that by itself may not be regarded as subjective but shows bias when analyzed as a whole. The triggering criteria may be implemented in various ways. The triggering criteria may be a rule(s) or a heuristic function for example. The triggering criteria may also be implemented using a learning algorithm. The learning algorithm may assign a confidence level to a triggering criterion or rule such that once reached the annotation may be removed instead of flagged. Actions other than removing or masking may be performed such as updating a list of flagged annotations and reducing or increasing the confidence level. A frequency chart that maintains the number of times a certain criterion or criteria is triggered may also be updated. The criterion may be may be a personally identifiable information (“PII”). In a different implementation, a different list may be maintained for the flagged annotations. The different list may be contained in the same text file.

After either flagging the annotation in the list or determining that the annotation does not match the triggering criteria, then the bias analyzer determines if there is another annotation (block 410). If there is another annotation, then the bias analyzer selects the next annotation for processing (block 404).

If the bias analyzer determines that there is no additional annotation (block 410), then the bias analyzer sends the data to the result processor (block 412). The data may be an updated version of the data received. The data maybe in another file separate from the data received. The data may be in a text file or any other file format. In another implementation, the data may be in a document or table stored in a database.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality provided as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

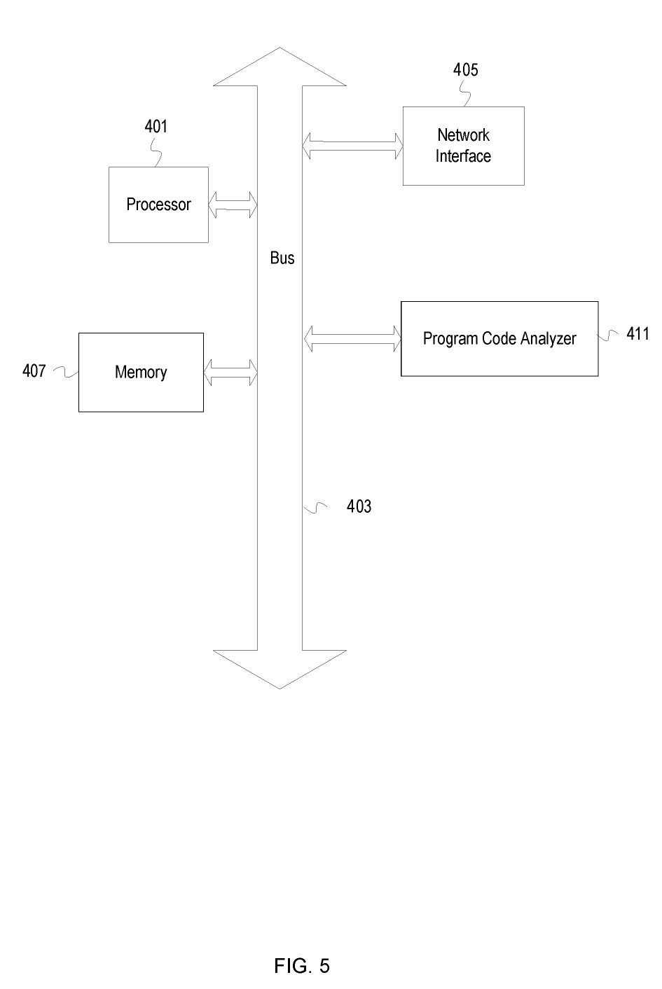

FIG. 5 depicts an example computer system that implements semantic bias correlation for source file content in accordance with an embodiment. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes a code analyzer system 511. The code analyzer system 511 provides program structures for partitioning annotations from program statements and generating annotation and program statement tokens that associate lexeme categories to annotation and program text. The code analyzer system 511 further provides program structures for comparing and correlating the program statement tokens with the annotation tokens and utilizing the correlations to map bias indicators to individual program statements.

Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for an object storage backed file system that efficiently manipulates namespace as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality shown as separate components in the example configurations may be implemented as a combined structure or component. Similarly, structures and functionality shown as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method for associating annotation semantic bias with program code, said method comprising:
separating an annotation from program statements contained within one or more source files;
generating program statement tokens corresponding to the program statements, wherein each of the program statement tokens associates program statement text with a programming language lexeme category;
generating one or more annotation tokens that each correspond to the annotation, wherein each of the annotation tokens associates annotation text with a natural language lexeme category;
comparing the program statement tokens with the annotation tokens;
determining a semantic correlation between the annotation and one or more of the program statements based, at least in part, on a result of said comparing;
determining a semantic bias associated with at least one of the annotation tokens; and
associating at least one of the one or more program statements with the determined semantic bias based, at least in part, on the determined semantic correlation.

2. The method of claim 1, further comprising:
identifying lexemes contained in the at least one of the annotation tokens; and
modifying the annotation based, at least in part, on the identified lexemes.

3. The method of claim 1, wherein said comparing the program statement tokens with the annotation tokens comprises:
generating an annotation syntax tree from the annotation tokens;
generating a program statement syntax tree from the program statement tokens;
selecting a compare rule based on a programming language lexeme category specified by at least one of the program statement tokens; and
applying the selected compare rule to select an annotation lexeme from the annotation syntax tree.

4. The method of claim 3, further comprising:
identifying a programming language syntax category of a program statement lexeme within the program statement syntax tree; and
selecting a program statement lexeme to be compared based, at least in part, on the identified programming language syntax category; and
wherein said applying the selected compare rule comprises selecting an annotation lexeme within the annotation syntax tree to be compared with the selected program statement lexeme based, at least in part, on the programming language lexeme category specified by the at least one of the program statement tokens.

5. The method of claim 1, wherein said determining a semantic correlation between the annotation and at least one of the program statements comprises:
selecting a program statement lexeme based on a compare rule;
determining synonyms for the program statement lexeme;
selecting an annotation lexeme based on,
the compare rule; and
the selected program statement lexeme;
determining synonyms for the annotation lexeme; and
pattern matching the synonyms for the program statement lexeme with the synonyms for the annotation lexeme.

6. The method of claim 5, further comprising generating a correlation report having an entry that associates an identifier of the annotation with identifiers of at least one of the program statements based on said pattern matching.

7. The method of claim 1, wherein said determining a semantic bias comprises:
applying a sentiment analysis algorithm to the annotation to determine a subjectivity indicator; and
comparing at least one lexeme within the annotation to bias associated character strings to determine a bias polarity.

8. The method of claim 7, further comprising generating an annotation bias report that associates an identifier of the annotation with the determined semantic bias.

9. One or non-transitory more machine-readable storage media having program code for associating annotation semantic bias with program statements stored therein, the program code to:
partition an annotation from program statements contained within one or more source files;
generate program statement tokens corresponding to the program statements, wherein each of the program statement tokens associates program statement text with a programming language lexeme category;
generate one or more annotation tokens that each correspond to the annotation, wherein each of the annotation tokens associates annotation text with a natural language lexeme category;
compare the program statement tokens with the annotation tokens;
determine a semantic correlation between the annotation and one or more of the program statements based, at least in part, on a result of said comparing;
determine a semantic bias associated with at least one of the annotation tokens; and
associate at least one of the one or more program statements with the determined semantic bias based, at least in part, on the determined semantic correlation.

10. The machine-readable storage media of claim 9, wherein the program code further includes program code to:
identify lexemes contained in the at least one of the annotation tokens; and
modify the annotation based, at least in part, on the identified lexemes.

11. The machine-readable storage media of claim 9, wherein the program code to compare the program statement tokens with the annotation tokens comprises program code to:
generate an annotation syntax tree from the annotation tokens;
generate a program statement syntax tree from the program statement tokens;
select a compare rule based on a programming language lexeme category specified by at least one of the program statement tokens; and
apply the selected compare rule to select an annotation lexeme from the annotation syntax tree.

12. The machine-readable storage media of claim 11, wherein the program code further includes program code to:
identify a programming language syntax category of a program statement lexeme within the program statement syntax tree; and
select a program statement lexeme to be compared based, at least in part, on the identified programming language syntax category; and
wherein the program code to apply the selected compare rule comprises program code to select an annotation lexeme within the annotation syntax tree to be compared with the selected program statement lexeme based, at least in part, on the programming language lexeme category specified by the at least one of the program statement tokens.

13. The machine-readable storage media of claim 9, wherein the program code to determine a semantic correlation between the annotation and at least one of the program statements comprises program code to:
select a program statement lexeme based on a compare rule;
determine synonyms for the program statement lexeme;
select an annotation lexeme based on,
the compare rule; and
the selected program statement lexeme;
determine synonyms for the annotation lexeme; and
pattern match the synonyms for the program statement lexeme with the synonyms for the annotation lexeme.

14. The machine-readable storage media of claim 13, wherein the program code further includes program code to generate a correlation report having an entry that associates an identifier of the annotation with identifiers of at least one of the program statements based on said pattern matching.

15. The machine-readable storage media of claim 9, wherein the program code to determine a semantic bias comprises program code to:
apply a sentiment analysis algorithm to the annotation to determine a subjectivity indicator; and
compare at least one lexeme within the annotation to bias associated character strings to determine a bias polarity.

16. The machine-readable storage media of claim 15, wherein the program code further includes program code to generate an annotation bias report that associates an identifier of the annotation with the determined semantic bias.

17. An apparatus comprising:
a processor; and
a machine-readable medium having program code executable by the processor to cause the apparatus to,
partition an annotation from program statements contained within one or more source files;
generate program statement tokens corresponding to the program statements, wherein each of the program statement tokens associates program statement text with a programming language lexeme category;
generate one or more annotation tokens that each correspond to the annotation, wherein each of the annotation tokens associates annotation text with a natural language lexeme category;
compare the program statement tokens with the annotation tokens;
determine a semantic correlation between the annotation and one or more of the program statements based, at least in part, on a result of said comparing;
determine a semantic bias associated with at least one of the annotation tokens; and
associate at least one of the one or more program statements with the determined semantic bias based, at least in part, on the determined semantic correlation.

18. The apparatus of claim 17, wherein the program code further includes program code executable by the processor to cause the apparatus to:
identify lexemes contained in the at least one of the annotation tokens; and
modify the annotation based, at least in part, on the identified lexemes.

19. The apparatus of claim 17, wherein the program code further includes program code executable by the processor to cause the apparatus to:
generate an annotation syntax tree from the annotation tokens;
generate a program statement syntax tree from the program statement tokens;
select a compare rule based on a programming language lexeme category specified by at least one of the program statement tokens; and
apply the selected compare rule to select an annotation lexeme from the annotation syntax tree.

20. The apparatus of claim 19, wherein the program code further includes program code executable by the processor to cause the apparatus to:
identify a programming language syntax category of a program statement lexeme within the program statement syntax tree; and
select a program statement lexeme to be compared based, at least in part, on the identified programming language syntax category; and
select an annotation lexeme within the annotation syntax tree to be compared with the selected program statement lexeme based, at least in part, on the programming language lexeme category specified by the at least one of the program statement tokens.
